(19) United States
(12) Patent Application Publication
(10) Pub. No.: US 2026/0267289 A1
(43) Pub. Date: Sep. 10, 2026

(54) DECORATIVE MEMBER FOR TIMEPIECE, AND METHOD FOR MANUFACTURING SAME

(71) Applicant: CITIZEN WATCH CO., LTD., Tokyo (JP)

(72) Inventors: Shinji Satoh, Tokyo (JP); Kotaro Takazaki, Tokyo (JP)

(73) Assignee: CITIZEN WATCH CO., LTD., Tokyo (JP)

(21) Appl. No.: 19/166,640

(22) PCT Filed: Feb. 16, 2024
(86) PCT No.: PCT/JP2024/005487

§ 371 Date: Sep. 18, 2025

(30) Foreign Application Priority Data
Mar. 23, 2023 (JP) 2023-046662

(51) Int. Cl. G04B 19/12; G04B 19/18; G04B 45/00

(52) U.S. Cl. CPC G04B 19/12; G04B 19/18; G04B 45/0015; G04B 45/0076

(57) ABSTRACT

A decorative member for a timepiece having excellent design properties is provided. The decorative member for a timepiece includes a light-transmitting member, a dielectric multilayer film covering one surface of the light-transmitting member and having an opening representing a predetermined pattern, a light-blocking layer covering the dielectric multilayer film, a first printed layer formed of light-transmitting paint and covering the opening of the dielectric multilayer film, and a second printed layer covering the first printed layer.

### FIELD

The present invention relates to a decorative member for a timepiece and a method for manufacturing the same.

### BACKGROUND

Various structures have been proposed to improve design properties in decorative members for timepieces. For example, Patent Literature 1 describes a rotary bezel body for a timepiece in which a color film is formed on the bottom of a transparent cover glass and luminous paint is applied.

### CITATION LIST

### Patent Literature

Patent Literature 1: Japanese Unexamined Patent Publication No. 5-1247

### SUMMARY

There is a demand for further improving design properties in decorative members for timepieces.

An object of the present disclosure is to provide a decorative member for a timepiece having excellent design properties and a method for manufacturing the same.

A decorative member for a timepiece of the present disclosure includes a light-transmitting member, a dielectric multilayer film covering one surface of the light-transmitting member and having an opening representing a predetermined pattern, a light-blocking layer covering the dielectric multilayer film, a first printed layer formed of light-transmitting paint and covering the opening of the dielectric multilayer film, and a second printed layer covering the first printed layer.

In the decorative member for a timepiece of the present disclosure, the first printed layer preferably further covers the light-blocking layer.

In the decorative member for a timepiece of the present disclosure, the paint forming the first printed layer is preferably luminous paint.

In the decorative member for a timepiece of the present disclosure, the dielectric multilayer film is preferably formed by laminating thin films; and the thin films preferably includes a first thin film having a first refractive index and a second thin film having a second refractive index different from the first refractive index.

In the decorative member for a timepiece of the present disclosure, the second printed layer preferably has a light-blocking property.

A method for manufacturing a decorative member for a timepiece of the present disclosure includes forming a dielectric multilayer film on one surface of a light-transmitting member; forming a light-blocking layer covering the dielectric multilayer film; forming an opening of a predetermined pattern in the dielectric multilayer film and the light-blocking layer; forming a first printed layer covering the opening of the dielectric multilayer film and the light-blocking layer, using light-transmitting paint; and forming a second printed layer covering the first printed layer.

The decorative member for a timepiece according to the present disclosure has excellent design properties. The manufacturing method of a decorative member for a timepiece according to the present disclosure enables manufacturing a decorative member for a timepiece having excellent design properties.

### BRIEF DESCRIPTION OF DRAWINGS

FIG. 1 is a plan view of a timepiece 1.

FIG. 2 is a plan view of a bezel 7.

FIG. 3 is a schematic cross-sectional view of the bezel 7.

FIG. 4 is a flow diagram showing an example of the flow of the manufacturing method of the bezel 7.

FIG. 5A is a schematic cross-sectional view of the bezel 7 immediately after a light-blocking layer formation step; FIG. 5B is a schematic cross-sectional view of the bezel 7 immediately after an opening formation step.

FIG. 6 is a flow diagram showing another example of the flow of the manufacturing method of the bezel 7.

FIG. 7A is a schematic cross-sectional view of the bezel 7 immediately after a mask formation step; FIG. 7B is a schematic cross-sectional view of the bezel 7 immediately after a light-blocking layer formation step; FIG. 7C is a schematic cross-sectional view of the bezel 7 immediately after a mask removal step.

FIG. 8 is a diagram showing the reflection characteristics of the bezel according to an example.

FIG. 9 is an image of the bezel according to the example.

### DESCRIPTION OF EMBODIMENTS

Various embodiments of the present disclosure will now be described with reference to the drawings. It should be noted that the technical scope of the present invention is not limited to these embodiments, but extends to the inventions described in the claims and their equivalents.

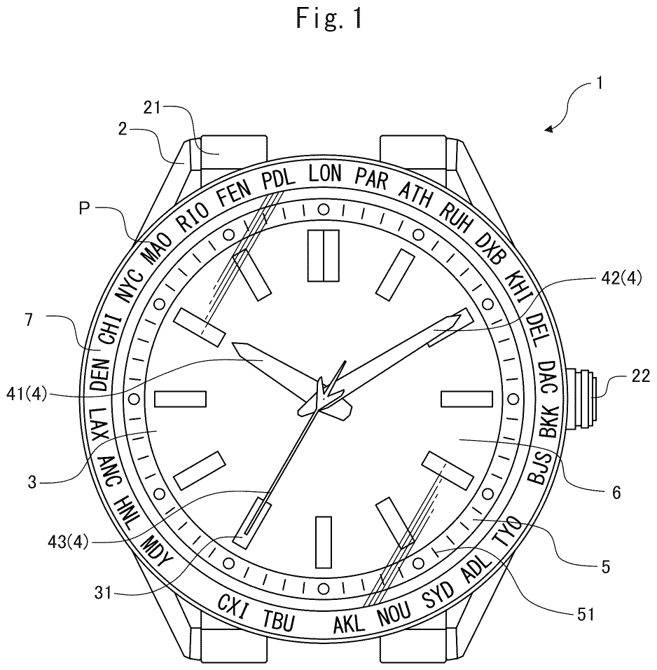

FIG. 1 is a plan view of a timepiece 1 according to an embodiment of the present disclosure. The timepiece 1 is a wristwatch and includes an exterior case 2, a dial 3, hands 4, a dial trim ring 5, a crystal 6, a bezel 7, and the like. The bezel 7 is an example of the decorative member for a timepiece.

The exterior case 2 is a substantially cylindrical member that houses each component of the timepiece 1. The exterior case 2 is made of a metal such as titanium or stainless steel, ceramic, or resin. On the side surface of the exterior case 2 on the 6 o'clock and 12 o'clock sides of the timepiece 1 are formed attachment portions 21 for attaching a strap (not shown). On the side surface of the exterior case 2 on the 3 o'clock side of the timepiece 1 is disposed a crown 22, which is inserted through the exterior case 2 and connected to the movement (not shown) of the timepiece 1.

The dial 3 is a disk-shaped member housed in the exterior case 2. On the dial 3, indices 31 are formed. The indices 31 may be formed by printing on the dial 3, working the dial 3, or disposing members having the shapes of the indices 31 on the dial 3. In the example shown in FIG. 1, twelve indices 31 are formed on the dial 3 at intervals of 30 degrees.

The hands 4 include an hour hand 41, a minute hand 42, and a second hand 43 disposed above the dial 3. The hour hand 41, the minute hand 42, and the second hand 43 rotate according to the rotational force transmitted from the movement, and indicate the time by pointing to some of the indices 31.

The dial trim ring 5 is an annular member disposed on the upper surface of the dial 3 so as to cover the outer periphery of the dial 3. In the example shown in FIG. 1, 60 minute markings 51 are formed on the dial trim ring 5 at intervals of 6 degrees.

The crystal 6 is a light-transmitting, disk-shaped member disposed above the dial 3 and the dial trim ring 5. The crystal 6 is made of, for example, sapphire glass, mineral glass, acrylic glass, or the like.

The bezel 7 is an annular member disposed on the upper surface of the exterior case 2 so as to surround the crystal 6. On the bezel 7, a predetermined decorative pattern P is displayed. In the example shown in FIG. 1, letters indicating city names are displayed as the decorative pattern P. The decorative pattern P is not limited to this example, and may be any characters, symbols, figures, or the like.

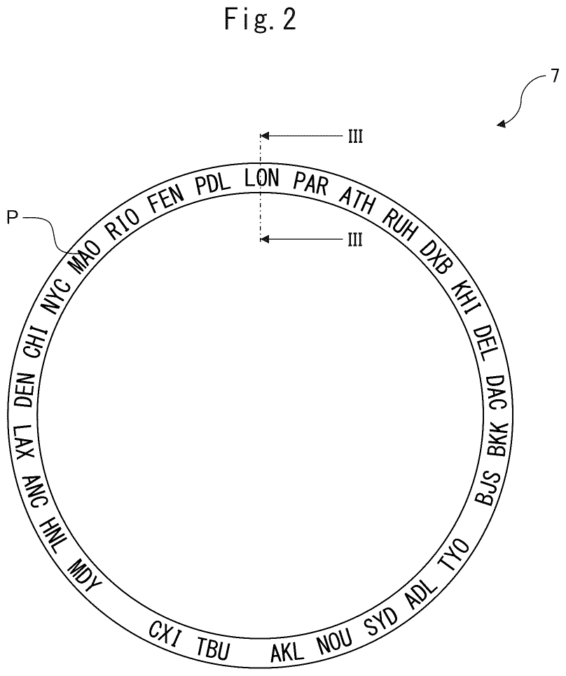

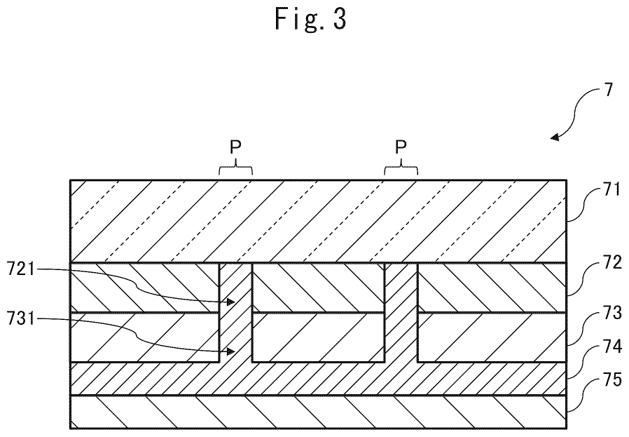

FIG. 2 is a plan view of the bezel 7; FIG. 3 is a schematic cross-sectional view of the bezel 7 taken along line III-III in FIG. 2. The bezel 7 includes a light-transmitting member 71, a dielectric multilayer film 72, a light-blocking layer 73, a first printed layer 74, and a second printed layer 75, which are disposed in this order from the front side of the timepiece 1 (the top in FIG. 3).

The light-transmitting member 71 is an annular member that transmits light. The light-transmitting member 71 is made of, for example, sapphire glass. Preferably, the light-transmitting member 71 is made of sapphire glass. The thickness of the light-transmitting member 71 is preferably 1.2 mm or more.

The dielectric multilayer film 72 is formed by laminating thin films made of dielectric materials so as to cover one surface of the light-transmitting member 71. Some of the thin films have a different refractive index than the others. In other words, the thin films includes a first thin film having a first refractive index and a second thin film having a second refractive index different from the first refractive index. The dielectric materials forming the thin films are, for example, high refractive index materials such as TiO₂, Nb₂O₅, Ta₂O₅, and ZrO₂, intermediate refractive index materials such as Al₂O₃, and low refractive index materials such as SiO₂ and MgF₂. The dielectric multilayer film 72 has different reflection characteristics depending on the incident angle of light because of the refractive indices of the materials and their film thicknesses, and thus appears to have different color tones depending on the line of sight.

The light-blocking layer 73 is formed to cover the dielectric multilayer film 72. The light-blocking layer 73 is made of a material having a high light-blocking property. The light-blocking layer 73 is made of, for example, a silver-white metal such as Cr, Ag, Ti, Zr, Al, Pt, Pd, or Rh, or an alloy thereof. The light-blocking layer 73 may be made of a colored metal such as Au, Cu, or a Au—Cu alloy, a metal nitride such as TiAlN, TiN, or CrN, or a non-metallic material such as diamond-like carbon (DLC). The thickness of the light-blocking layer 73 is preferably 10 nm or more. This allows the light-blocking layer 73 to have a high light-blocking property and the color tones of the dielectric multilayer film 72 to be clearly seen.

Openings 721 and 731 representing the decorative pattern P are formed in the dielectric multilayer film 72 and the light-blocking layer 73, respectively. More specifically, openings 721 are formed in regions corresponding to the decorative pattern P of the dielectric multilayer film 72, and openings 731 are formed in regions corresponding to the decorative pattern P of the light-blocking layer 73. This results in the dielectric multilayer film 72 and the light-blocking layer 73 representing the decorative pattern P.

The first printed layer 74 is formed of light-transmitting paint. The first printed layer 74 fills the openings 721 of the dielectric multilayer film 72 and the openings 731 of the light-blocking layer 73, thereby covering the openings 721 of the dielectric multilayer film 72 and the openings 731 of the light-blocking layer 73. Further, the first printed layer 74 covers the light-blocking layer 73. The thickness of the first printed layer 74 (the distance between the light-blocking layer 73 and the second printed layer 75) is preferably 2 μm or more and 30 μm or less.

The paint forming the first printed layer 74 is preferably luminous paint having phosphorescent pigments such as aluminate-based or sulfide-based pigments dispersed in a light-transmitting resin. This results in the regions of the decorative pattern P emitting light in the dark, making the decorative pattern P easily seen and providing the bezel 7 with excellent design properties.

The second printed layer 75 is formed of paint and is disposed so as to cover the first printed layer 74. The paint forming the second printed layer 75 has a high light-blocking property. The paint forming the second printed layer 75 is preferably white paint. Since the first printed layer 74 is formed of light-transmitting paint, the decorative pattern P appears white by the second printed layer 75 formed of white paint. Since the dielectric multilayer film 72 strongly reflects light of a particular color in general, the fact that the decorative pattern P appears white enables clearly distinguishing the colors of the dielectric multilayer film 72 and the decorative pattern P and makes the decorative pattern P easily seen.

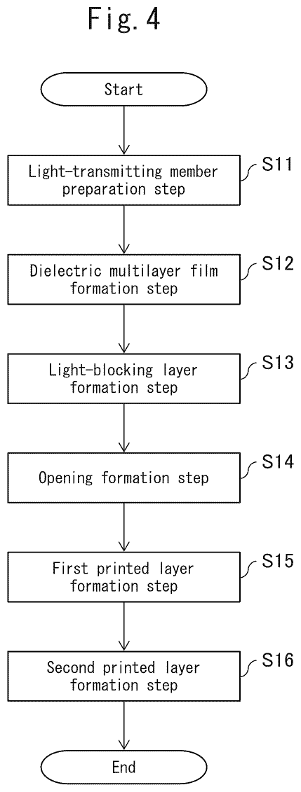

FIG. 4 is a flow diagram showing an example of the flow of the manufacturing method of the bezel 7.

First, in a light-transmitting member preparation step (step S11), a light-transmitting member 71 is prepared.

Next, in a dielectric multilayer film formation step (step S12), a dielectric multilayer film 72 covering one surface of the light-transmitting member 71 is formed. The dielectric multilayer film 72 is formed by sequentially laminating thin films on one surface of the light-transmitting member 71. Each thin film is formed by laminating a dielectric material on one surface of the light-transmitting member 71 by vacuum deposition. Each thin film may be formed by sputtering, arc ion plating, chemical vapor deposition (CVD), or the like. The thicknesses of the thin films may vary depending on the position on the surface of the light-transmitting member 71. For example, by using a blocking mask to prevent deposition at laminating some of the thin films, the thicknesses of the thin films can be made to vary depending on the position. When the thicknesses of the thin films are changed using a blocking mask in this manner, a gradation color having various hues can be formed.

Next, in a light-blocking layer formation step (step S13), a light-blocking layer 73 covering the dielectric multilayer film 72 is formed. The light-blocking layer 73 is formed by laminating a material such as a metal, a metal nitride, or DLC on the dielectric multilayer film 72 by vapor deposition. The light-blocking layer 73 may be formed by sputtering, arc ion plating, CVD, or the like.

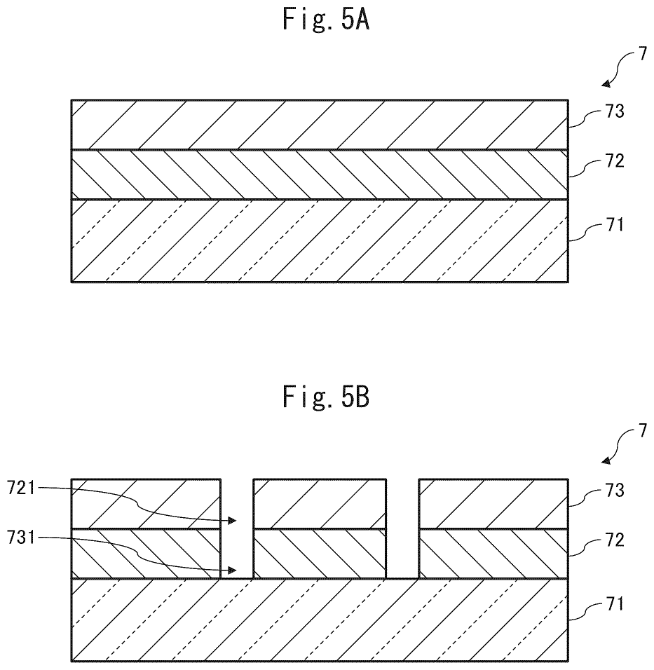

FIG. 5A is a schematic cross-sectional view of the bezel 7 immediately after the light-blocking layer formation step. As shown in FIG. 5A, a dielectric multilayer film 72 and a light-blocking layer 73 are uniformly laminated on one surface of the light-transmitting member 71 immediately after the light-blocking layer formation step. In other words, no openings 721 and 731 are formed in the dielectric multilayer film 72 and the light-blocking layer 73.

Returning to FIG. 4, in an opening formation step (step S14), openings 721 and 731 representing a decorative pattern P are then formed in the dielectric multilayer film 72 and the light-blocking layer 73. The openings 721 and 731 are formed by removing regions corresponding to the decorative pattern P of the dielectric multilayer film 72 and the light-blocking layer 73 by etching. Etching is performed by laser irradiation or with a solution.

FIG. 5B is a schematic cross-sectional view of the bezel 7 immediately after the opening formation step. As shown in FIG. 5B, openings 721 are formed in the regions corresponding to the decorative pattern P of the dielectric multilayer film 72, and openings 731 are formed in the regions corresponding to the decorative pattern P of the light-blocking layer 73, immediately after the opening formation step.

Returning to FIG. 4, in a first printed layer formation step (step S15), a first printed layer 74 covering the openings 721 and 731 of the dielectric multilayer film 72 and the light-blocking layer 73 is then formed. The first printed layer 74 is formed by applying light-transmitting paint to the light-blocking layer 73 by pad printing. The first printed layer 74 may be formed by screen printing, painting, or the like.

Next, in a second printed layer formation step (step S16), a second printed layer 75 covering the first printed layer 74 is formed. The second printed layer 75 is formed by applying paint to the first printed layer 74 by pad printing. The second printed layer 75 may be formed by screen printing, painting, or the like. In this manner, the bezel 7 is manufactured.

As described above, the bezel 7 includes a light-transmitting member 71, a dielectric multilayer film 72 covering one surface of the light-transmitting member 71 and having an opening 721 representing a decorative pattern P, a light-blocking layer 73 covering the dielectric multilayer film 72, a first printed layer 74 formed of light-transmitting paint and covering the opening of the dielectric multilayer film 72, and a second printed layer 75 covering the first printed layer 74. This provides the bezel 7 with excellent design properties.

More specifically, the dielectric multilayer film 72, which has different reflection characteristics depending on the incident angle of light, appears to have different color tones depending on the line of sight. Further, the openings 721 representing the decorative pattern P are formed in the dielectric multilayer film 72, and the first printed layer 74 covering the openings 721 is formed of light-transmitting paint, so that the regions corresponding to the decorative pattern P appear to have a color tone corresponding to the second printed layer 75.

Since the decorative pattern P appears to have a constant color tone and the region other than the decorative pattern P appears to have different color tones depending on the line of sight, the bezel 7 has excellent design properties.

In the bezel 7, the paint forming the first printed layer 74 is preferably luminous paint. The first printed layer 74 formed of luminous paint results in the regions of the decorative pattern P emitting light in the dark, making the decorative pattern P easily seen and providing the bezel 7 with different design properties than in the light.

In the bezel 7, the paint forming the second printed layer 75 is preferably white paint. Since a dielectric multilayer film strongly reflects light of a particular color and thus as appears to be a colored film in general, the second printed layer 75 formed of white paint makes the decorative pattern P easily seen. When the first printed layer 74 is formed of luminous paint, the second printed layer 75 formed of white paint strongly reflects light emitted from the first printed layer, making the decorative pattern P more easily seen.

In the above description, the first printed layer 74 covers the openings 721 and 731 of the dielectric multilayer film 72 and the light-blocking layer 73, and also covers the light-blocking layer 73; however, the invention is not limited to this example. The first printed layer 74 may cover only the openings 721 and 731 of the dielectric multilayer film 72 and the light-blocking layer 73 without covering the light-blocking layer 73. In other words, the first printed layer 74 may be formed only inside the openings 721 of the dielectric multilayer film 72 and the openings 731 of the light-blocking layer 73. Even in this case, the bezel 7 has excellent design properties.

In the above description, the openings 721 and 731 are formed in the regions corresponding to the decorative pattern P of the dielectric multilayer film 72 and the light-blocking layer 73, respectively, so that the dielectric multilayer film 72 and the light-blocking layer 73 represent the decorative pattern P; however, the invention is not limited to this example. For example, the dielectric multilayer film 72 and the light-blocking layer 73 may be formed only in the regions corresponding to the decorative pattern P, so that the dielectric multilayer film 72 and the light-blocking layer 73 represent the decorative pattern P. Even in this case, the bezel 7 has excellent design properties.

In the above description, the bezel 7 is manufactured by the manufacturing method shown in the flow diagram of FIG. 4; however, the manufacturing method is not limited to this example.

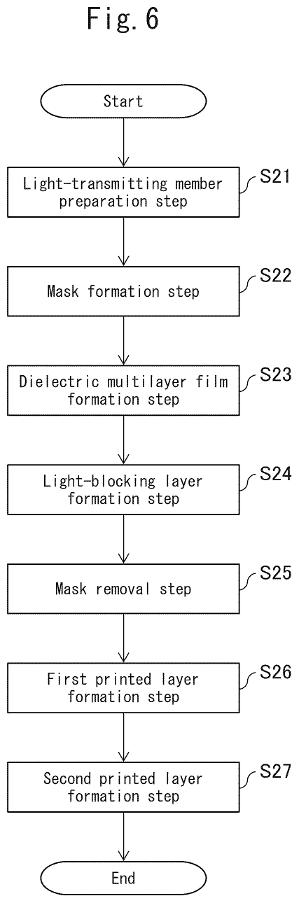

FIG. 6 is a flow diagram showing another example of the flow of the manufacturing method of the bezel 7.

First, in a light-transmitting member preparation step (step S21), a light-transmitting member 71 is prepared in the same manner as in step S11.

Next, in a mask formation step (step S22), a mask M is formed in regions corresponding to a decorative pattern P on one surface of the light-transmitting member 71. The mask M is formed by applying resin to one surface of the light-transmitting member 71 by pad printing. The mask M may be formed by screen printing, painting, or the like.

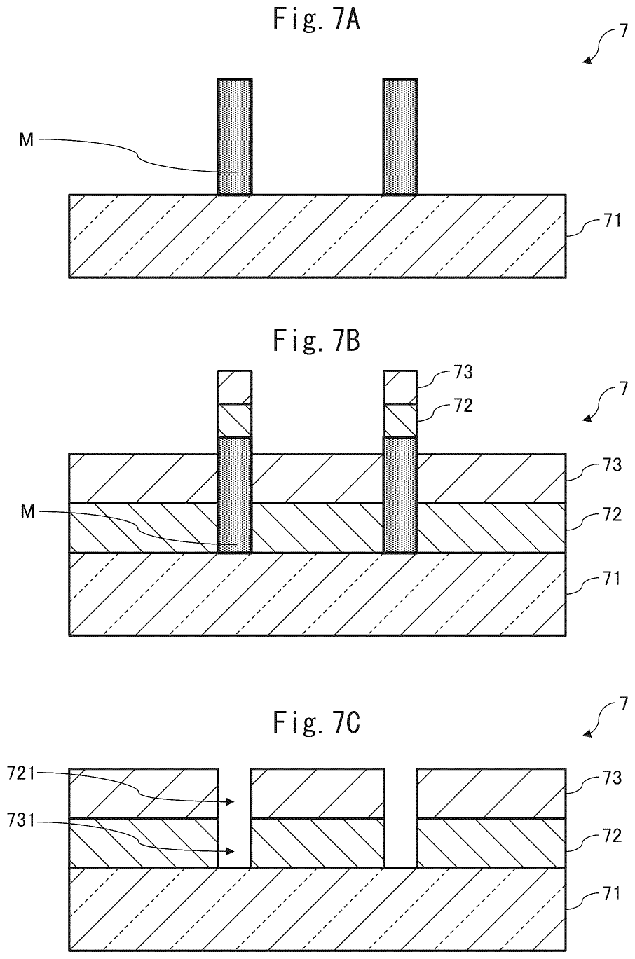

FIG. 7A is a schematic cross-sectional view of the bezel 7 immediately after the mask formation step. As shown in FIG. 5A, a mask M is formed in regions corresponding to a decorative pattern P on one surface of the light-transmitting member 71 immediately after the mask formation step.

Returning to FIG. 6, in a dielectric multilayer film formation step (step S23), a dielectric multilayer film 72 is formed in the same manner as in step S12. In the regions corresponding to the decorative pattern P at this time, the dielectric multilayer film 72 is formed on the mask M rather than on the surface of the light-transmitting member 71 because the mask M is formed.

Next, in a light-blocking layer formation step (step S24), a light-blocking layer 73 is formed in the same manner as in step S13. In the regions corresponding to the decorative pattern P at this time, the light-blocking layer 73 is formed to cover the dielectric multilayer film 72 on the mask M because the mask M is formed.

FIG. 7B is a schematic cross-sectional view of the bezel 7 immediately after the light-blocking layer formation step. Since the mask M is formed in the regions corresponding to the decorative pattern P of the light-transmitting member 71, the dielectric multilayer film 72 and the light-blocking layer 73 are formed on the mask M and in the region except the regions corresponding to the decorative pattern P on the one surface of the light-transmitting member 71.

Returning to FIG. 6, in a mask removal step (step S25), the mask M formed on the one surface of the light-transmitting member 71 is removed together with the dielectric multilayer film 72 and the light-blocking layer 73 formed on the mask M. This results in openings 721 and 731 representing the decorative pattern P being formed in the dielectric multilayer film 72 and the light-blocking layer 73. The mask M is removed by immersing the light-transmitting member 71 in an organic solvent such as acetone or ethanol. The light-transmitting member 71 immersed in the organic solvent may be irradiated with ultrasonic waves. This allows the mask M to be removed more efficiently.

FIG. 7C is a schematic cross-sectional view of the bezel 7 immediately after the mask removal step. By removing the mask M formed in the regions corresponding to the decorative pattern P of the light-transmitting member 71, openings 721 and 731 are formed in the regions corresponding to the decorative pattern P of the dielectric multilayer film 72 and the light-blocking layer 73, i.e., the regions where the mask M was formed.

Returning to FIG. 6, in a first printed layer formation step (step S26), a first printed layer 74 is then formed in the same manner as in step S15.

Next, in a second printed layer formation step (step S27), a second printed layer 75 is formed in the same manner as in step S16. In this manner, the bezel 7 is manufactured.

The bezel 7 manufactured in this manner has excellent design properties, similar to the bezel 7 manufactured by the manufacturing method shown in the flow diagram of FIG. 4.

In the above description, the decorative member for a timepiece is the bezel 7; however, the invention is not limited to this example. The decorative member for a timepiece may be the dial 3 or the dial trim ring 5. When the decorative member for a timepiece is the dial 3, the dial 3 has the structure shown in the cross-sectional view of FIG. 3 and is manufactured by the manufacturing method shown in the flow diagram of FIG. 4 or 6. In this case, the decorative pattern P is, for example, the indices 31. When the decorative member for a timepiece is the dial trim ring 5, the dial trim ring 5 has the structure shown in the cross-sectional view of FIG. 3 and is manufactured by the manufacturing method shown in the flow diagram of FIG. 4 or 6. In this case, the decorative pattern P is, for example, the minute markings 51. Alternatively, the decorative member for a timepiece may be the hands 4 showing a predetermined decorative pattern.

### EXAMPLE

A bezel according to an example was manufactured by the manufacturing method shown in the flow diagram of FIG. 4.

First, in step S11, an annular light-transmitting member made of sapphire glass and having a thickness of 1.2 mm was prepared.

Next, in step S12, the light-transmitting member was placed in a vacuum deposition apparatus. A dielectric multilayer film was formed on one surface of the light-transmitting member by alternately laminating five thin films made of TiO₂ and five thin films made of SiO₂, i.e., ten thin films in total. The thin films were formed to have thicknesses of 42 nm, 52 nm, 52 nm, 21 nm, 100 nm, 53 nm, 39 nm, 38 nm, 76 nm, and 136 nm, respectively, in this order from the light-transmitting member side so that the dielectric multilayer film would appear blue.

Next, in step S13, a light-blocking layer was formed by evaporating Cr onto the one surface of the light-transmitting member. The light-blocking layer was formed to have a thickness of 50 nm.

Next, in step S14, the light-transmitting member was taken out of the vacuum deposition apparatus. Thereafter, openings 721 and 731 representing a decorative pattern P were formed in the dielectric multilayer film 72 and the light-blocking layer 73 by etching performed by laser irradiation.

Next, in step S15, the light-transmitting member was cleaned. Thereafter, luminous paint was applied to the light-blocking layer by pad printing to form a first printed layer. The first printed layer was formed to have a thickness of 5 μm.

Next, in step S16, white paint was applied to the first printed layer by pad printing to form a second printed layer. The second printed layer was formed to have a thickness of 10 μm. In this manner, the bezel according to the example was manufactured.

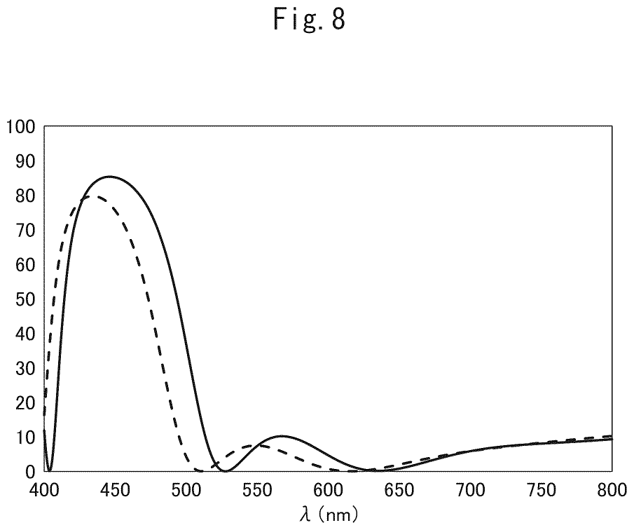

FIG. 8 is a diagram showing the reflection characteristics of the bezel according to the example, measured immediately after step S13. In the graph of FIG. 8, the horizontal axis is wavelength, and the vertical axis is reflectance expressed as a percentage. The solid line in the graph of FIG. 8 indicates the reflection characteristic for light with an incident angle of 0 degrees, and the dashed line indicates the reflection characteristic for light with an incident angle of 30 degrees. The incident angle is the angle with respect to the normal direction of the light-transmitting member.

As shown in FIG. 8, the peak wavelengths of the reflection characteristic for light with an incident angle of 0 degrees and the reflection characteristic for light with an incident angle of 30 degrees were both less than 450 nm and were slightly different. Thus the bezel according to the example appeared blue with the color tones slightly varying depending on the location.

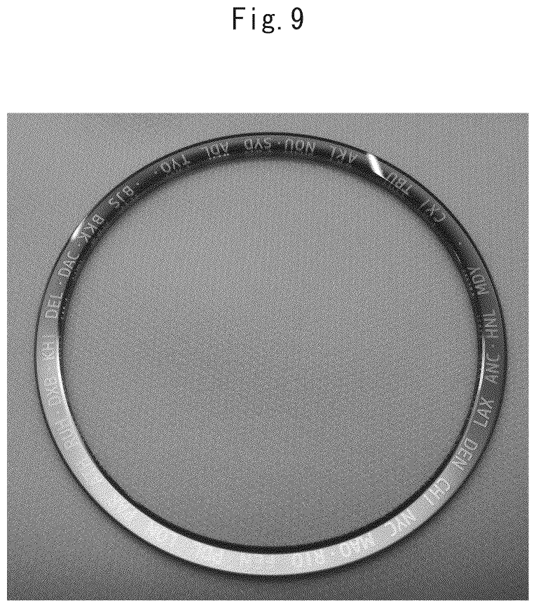

FIG. 9 is an image of the bezel according to the example. As shown in FIG. 9, the bezel according to the example had different color tones depending on the location. Although the hue is not shown in FIG. 9, the bezel according to the example appeared to have color tones that changed from blue-purple to blue-green from the upper right to the lower left. Further, the character strings of the decorative pattern P appeared white, and thus could be easily distinguished from the blue dielectric multilayer film. In this manner, the bezel according to the example was confirmed to have excellent design properties and allow the decorative pattern to be easily visible.

It should be understood by those skilled in the art that various changes, substitutions, and alterations can be made without departing from the scope of the present disclosure. For example, the above-described embodiments and modifications may be implemented in any suitable combination within the scope of the present disclosure.

1. A decorative member for a timepiece, comprising:
a light-transmitting member;
a dielectric multilayer film covering one surface of the light-transmitting member and having an opening representing a predetermined pattern;
a light-blocking layer covering the dielectric multilayer film;
a first printed layer formed of light-transmitting paint and covering the opening of the dielectric multilayer film; and
a second printed layer covering the first printed layer.

2. The decorative member for a timepiece according to claim 1, wherein
the first printed layer further covers the light-blocking layer.

3. The decorative member for a timepiece according to claim 1, wherein
the paint forming the first printed layer is luminous paint.

4. The decorative member for a timepiece according to claim 1, wherein
the dielectric multilayer film is formed by laminating thin films, and
the thin films includes a first thin film having a first refractive index and a second thin film having a second refractive index different from the first refractive index.

5. The decorative member for a timepiece according to claim 1, wherein
the second printed layer has a light-blocking property.

6. A method for manufacturing a decorative member for a timepiece, the method comprising:
forming a dielectric multilayer film on one surface of a light-transmitting member;
forming a light-blocking layer covering the dielectric multilayer film;
forming an opening representing a predetermined pattern in the dielectric multilayer film and the light-blocking layer;
forming a first printed layer covering the opening of the dielectric multilayer film and the light-blocking layer, using light-transmitting paint; and
forming a second printed layer covering the first printed layer.
